(19) United States
(12) Patent Application Publication
(10) Pub. No.: US 2024/0262986 A1
(43) Pub. Date: Aug. 8, 2024

(54) COMPOSITION CONTAINING SPINEL-TYPE METAL OXIDES

(71) Applicant: The Research Center for Advanced Materials Science, King Khalid University (KKU), Abha (SA)

(72) Inventors: Abdullah G. AL-SEHEMI, Abha (SA); Ahmed A. AL-GHAMDI, Jeddah (SA); Nikolay Todorov DISHOVSKY, Sofia (GB); Nikolay Todorov ATANASOV, Sofia (GB); Gabriela Lachezarova ATANASOVA, Sofia (GB); Irena Kirilova MIHAYLOVA, Sofia (GB); Petrunka Atanasova MALINOVA, Sofia (GB)

(73) Assignee: The Research Center for Advanced Materials Science, King Khalid University (KKU), Abha (SA)

(21) Appl. No.: 18/163,513

(22) Filed: Feb. 2, 2023

(51) Int. Cl. C08K 13/02; C08L 9/06

(52) U.S. Cl. CPC C08K 13/02; C08L 9/06; C08K 2003/2296; C08K 3/30; C08K 5/09; C08K 2201/005

(57) ABSTRACT

A composition of styrene butadiene rubber containing spinel type metal oxides and will find application for insulating layers and supports in flexible antennas that can be worn close to the human body without adversely affecting it. The composition contains spinel-type metal oxides, in which the ingredients per 100 mass parts of styrene butadiene rubber/SBR/are: zinc oxide from 1 to 5 mass parts, stearic acid from 1 to 2 mass parts, filler from 25 to 75 mass parts, vulcanization accelerator/TBBS/—from 1 to 1.5 mass parts, sulfur from 1.5 to 2.0 and the filler is spinel type metal oxides and is Zn_{0.53}Co_{0.48}Mn_{0.01}Cr₂O₄. The spinel type of metal oxides has the following chemical composition in weight percentages: Cr—62, 10; Mn—0, 19; Co—16, 92; Zn—20, 79, and particle sizes range from submicron 0.2-0.5 μm to 2-3 μm.

### FIELD

The present invention relates to a styrene butadiene rubber composition containing spinel-type metal oxides and will find application in insulating layers and substrates in flexible antennas that can be worn close to the human body without adversely affecting it.

### BACKGROUND

There is a known patent document CN110808159A relating to Method for manufacturing electromagnetic conductive contact of iron-nickel-based composite material by sol-gel method. The invention discloses a method for producing an electromagnetically conductive composite material based on iron-nickel by the sol-gel method. The resin-based magnetic core is produced by producing an alloy oxide crystal with a spinel-like structure, grinding the material into a powder, mixing it with a silver powder functional additive, and embedding it into a secondary vulcanized colloidal material that is formed by mechanical mixing polymethyl silicone resin, silicon dioxide, polymethyl vinyl silicone rubber and starch-grafted sodium acrylate, which is mixed with the filler in powder form. Electromagnetic conductive composite material has small band width, good electrical conductivity, high overall strength, high magnetic permeability and self-wear resistance.

There is known from CN112812573A Method for preparing silicone rubber composite heat insulation material by using wastewater treatment precipitate as flame-retardant filler. A method of producing a silicone rubber composite thermal insulation material by using sewage sludge as a refractory filler is disclosed. According to the invention, chromium-containing wastewater and waste from flue gas desulfurization with magnesium oxide are used as raw materials for synthesizing chromium-magnesium spinel powder. Chromium-magnesium spinel in powder form is added as a refractory filler.

There is a known patent document CN104130536A Three-phase composite microstrip antenna substrate material and preparation method thereof. The invention relates to a three-phase composite material for a microstrip antenna. The three-phase composite substrate material for microstrip antenna is prepared by: mixing 10-15 mass parts of magnetic filler, 25-30 mass parts of dielectric filler and 60 mass parts of polymer, where the magnetic filler is ferroferric oxide with a spinel structure and the molecular formula is Fe₃O₄; the dielectric filler is rutile titanium dioxide and the molecular formula is TiO₂; and the polymer substrate is polytetrafluoroethylene (PTFE) resin. According to the invention, the prepared composite material is used for a microstrip antenna, the weight and size of the microstrip antenna are reduced, and the bandwidth and radiation efficiency of the microstrip antenna are increased. The size of the dust particles is from 2 mm to 6 mm.

Patent document JP2022030195A THERMOSETTING RESIN COMPOSITION FOR LDS, RESIN MOLDED ARTICLE, AND THREE-DIMENSIONAL MOLDED CIRCUIT COMPONENT is also known. The thermosetting resin composition for LDS of the invention includes a thermosetting resin, an inorganic filler, a non-conductive metal compound that forms a metal nucleus upon irradiation with active energy rays, and a coupling agent, in which the non-conductive metal compound includes one or more selected from the group consisting of a spinel-type metal oxide, a metal oxide having two or more transition metal elements in groups adjacent to each other, the groups being selected from groups 3 to 12 of the periodic table, and a tin-containing oxide, and the coupling agent includes one or more selected from the group, composed of an inorganic material having a relative dielectric constant of 5 or greater. The spinel type of metal oxide can be: AB₂O₄ type of compounds (A and B are metallic elements) which are constituent oxides. Either a front spinel structure or an inverted spinel structure (B(AB)O₄) in which A and B are partially interchanged can be used, but more preferably the front spinel structure can be used. In this case, the A of the front spinel structure may be copper. As the metal atom constituting the spinel-type metal oxide, for example, copper or chromium can be used. This means that the non-conductive metal compound may contain a spinel type metal oxide containing copper or chromium. For example, copper can be used as a metal atom in terms of adhesion to the copper coating pattern.

### SUMMARY

The aim of the present invention is to create a composition that finds application in insulating layers and substrates in flexible antennas, providing a small value of the tangent of the dielectric loss angle (tan δ_{ε}), minimal absorption of electromagnetic power, a good balance of mechanical parameters contributing for the necessary flexibility, the ability to withstand mechanical loads and to have a low variation of the complex dielectric permittivity in a wide frequency range.

The goal is achieved with a composition containing spinel-type metal oxides, in which the ingredients per 100 parts of styrene butadiene rubber/SBR/are: zinc oxide from 1 to 5 mass parts, stearic acid from 1 to 2 mass parts, filler from 25 to 75 mass parts, vulcanization accelerator/TBBS/—from 1 to 1.5 mass parts, sulfur from 1.5 to 2.0, and the filler is a spinel type of metal oxides and is Zn_{0.53}Co_{0.48}Mn_{0.01}Cr₂O₄.

According to the invention, the spinel type of metal oxides has the following chemical composition in weight percentages: Cr—62.10; Mn—0.19; Co—16.92; Zn—20, 79, and the particle sizes range from submicron 0.2-0.5 μm to 2-3 μm.

The composition will find applications in the preparation of insulating layers and substrates in flexible antennas that can be worn close to the human body without adversely affecting it. Flexible antennas are a subclass of microstrip antennas. The difference between them is that flexible antennas are near or on the human body without having an adverse effect on it. That is why they must be comfortable, flexible and not contribute to discomfort. At the same time, they must have a small value of the tangent of the dielectric loss angle (tan δ_{ε}), minimal absorption of electromagnetic power, the ability to withstand mechanical loads and have a small variation of the complex dielectric permittivity in a wide frequency range.

Inorganic pigments are an important group of additives. It is known to date that spinel-type metal oxides impart color to the materials to which they are added, but can also improve their applied properties, such as light resistance and flammability. The spinel type of metal oxides have the general formula AB₂O₄. They are resistant to sunlight, heat and environmental changes. The spinel system A₂+B₃+2O₄ consists of divalent (2+) and trivalent (3+) metal ions in one of two different coordination environments. Another type of spinel pigment is the B[AB]O₄ spinel system. Known as “inverse spinels,” A represents metal ions arranged in octahedral structures, while B ions occur in tetrahedral and octahedral sites. Spinel pigments have found wide application as catalysts, semiconductors, and magnetic ceramic powders. As colorants, these pigments are most often used in ceramics because of their chemical and thermal stability.

The use of spinel-type metal oxides as filler mixtures has so far only been known for microstrip antennas that are solid.

For the purposes of the invention, studies were carried out on the effect of the filler spinel type of metal oxides on the complex of properties of compositions based on butadiene styrene rubber.

To date, there have been no studies describing the influence of spinel-type metal oxides used as fillers on the entire complex of properties of compositions based on butadiene styrene rubber.

Unexpectedly, the conducted studies prove an expansion of the possible applications of compositions based on butadiene styrene rubber containing spinel-type metal oxides as fillers.

According to the present invention, a spinel type of metal oxides, characterized as follows, is included in the composition as a filler:

Characterization of the spinel-type metal oxide fillers used

The X-ray diffractogram of the used filler is presented in FIG. 1.

From the X-ray phase analysis, it can be concluded that the main phase of the filler is chromium-bearing spinel, but there are also traces of Cr₂O₃ (eskolaite) phase. According to the obtained result, the chemical composition is: Cr—1.99; Mn—0.01; Co—0.48; Zn—0.53. If we abstract from the minimal amount of chromium oxide phase, the spinel formula is Zn_{0.53}Co_{0.48}Mn_{0.01}Cr₂O₄. Chemical composition in weight percentages is: Cr—62, 10; Mn—0, 19;Co—16, 92; Zn—20, 79.

The SEM micrographs are images of the investigated filler FIG. 2, respectively

FIG. 2.a-FIG. 2.f—in secondary electron image mode; FIG. 2.g and FIG. 2.h—in the backscattered electron image mode, the morphology of the filler used, which is a homogeneous fine powder, is shown. Particle sizes range from submicron to 2-3 μm. The particles have an isometric habit. The triangular walls of octahedral crystals can be distinguished in the photomicrographs.

By means of EDX, the composition in microzones and in items was investigated/FIG. 3 and FIG. 4/.

FIG. 3 shows the results obtained by means of EDX in microzones FIG. 3.1—Zone 1 and FIG. 3.2—Zone 2

TABLE 1
Established composition in zone 1
Zone 1 Spectrum: Acquisition 11922

| | | | unn. C | norm. C | Atom. C | Error |
|---|---|---|---|---|---|---|
| El | AN | Series | [wt. %] | [wt. %] | [at. %] | [%] |
| O | 8 | K-series | 31.02 | 32.83 | 62.55 | 6.0 |
| Cr | 24 | K-series | 37.94 | 40.16 | 23.54 | 1.1 |
| Co | 27 | K-series | 12.65 | 13.39 | 6.93 | 0.4 |
| Zn | 30 | K-series | 10.75 | 11.37 | 5.30 | 0.4 |
| Si | 14 | K-series | 0.56 | 0.59 | 0.65 | 0.1 |
| Mn | 25 | K-series | 1.04 | 1.11 | 0.61 | 0.3 |
| Ca | 20 | K-series | 0.51 | 0.54 | 0.41 | 0.1 |
| Total: | | | 94.48 | 100.00 | 100.00 | |

Formula for Zone 1: Ca_{0.03}Zn_{0.43}Co_{0.56}Mn_{0.05}Cr_{1.87}Si_{0.06}O₄

TABLE 2
Established composition in zone 2
Zone 2 Spectrum: Acquisition 11924

| | | | unn. C | norm. C | Atom. C | Error |
|---|---|---|---|---|---|---|
| El | AN | Series | [wt. %] | [wt. %] | [at. %] | [%] |
| O | 8 | K-series | 29.00 | 29.54 | 50.58 | 7.8 |
| Cr | 24 | K-series | 39.74 | 40.48 | 21.33 | 1.2 |
| C | 6 | K-series | 7.90 | 8.05 | 18.35 | 1.6 |
| Zn | 30 | K-series | 10.78 | 10.98 | 4.60 | 0.5 |
| Co | 27 | K-series | 9.32 | 9.49 | 4.41 | 0.4 |
| Mn | 25 | K-series | 1.43 | 1.46 | 0.73 | 0.5 |
| Total: | | | 98.16 | 100.00 | 100.00 | |

Formula for Zone 2: Zn_{0.45}Co_{0.43}Mn_{0.07}Cr_{2.06}O₄

The compositions found in the zones are similar, small amounts of Ca and Si (˜ 0.5 wt %) were found in one of the zones. These elements are probably due to impurities that have entered the sample.

In FIG. 4.1, FIG. 4.2 and FIG. 4.3 are results obtained by means of EDX in points 1, 2 and 3.

TABLE 3
Established composition in point 1
Item 1 Spectrum: Acquisition 11923

| | | | unn. C | norm. C | Atom. C | Error |
|---|---|---|---|---|---|---|
| El | AN | Series | [wt. %] | [wt. %] | [at. %] | [%] |
| O | 8 | K-series | 40.08 | 37.71 | 59.63 | 7.2 |
| Cr | 24 | K-series | 36.78 | 34.60 | 16.83 | 1.0 |
| C | 6 | K-series | 7.64 | 7.19 | 15.14 | 1.2 |
| Co | 27 | K-series | 10.28 | 9.67 | 4.15 | 0.3 |
| Zn | 30 | K-series | 10.62 | 9.99 | 3.86 | 0.4 |
| Mn | 25 | K-series | 0.89 | 0.84 | 0.39 | 0. |
| Total: | | | 106.30 | 100.00 | 100.00 | |

Formula for item 1: Zn_{0.49}Co_{0.47}Mn_{0.04}Cr₂O₄

TABLE 4
Established composition in point 2
Item 2 Spectrum: Acquisition 11926

| | | | unn. C | norm. C | Atom. C | Error |
|---|---|---|---|---|---|---|
| El | AN | Series | [wt. %] | [wt. %] | [at. %] | [%] |
| O | 8 | K-series | 61.52 | 55.87 | 64.92 | 12.8 |
| Mg | 12 | K-series | 19.23 | 17.46 | 13.36 | 1.1 |
| C | 6 | K-series | 5.66 | 5.14 | 7.95 | 1.4 |
| Si | 14 | K-series | 11.76 | 10.68 | 7.07 | 0.6 |
| Al | 13 | K-series | 9.47 | 8.60 | 5.92 | 0.5 |
| Fe | 26 | K-series | 1.44 | 1.31 | 0.44 | 0.1 |
| Cr | 24 | K-series | 1.03 | 0.94 | 0.34 | 0.1 |
| Total: | | | 110.10 | 100.00 | 100.00 | |

TABLE 5
Established composition in point 3.
Item 3 Spectrum: Acquisition 11928

| | | | unn. C | norm. C | Atom. C | Error |
|---|---|---|---|---|---|---|
| El | AN | Series | [wt. %] | [wt. %] | [at. %] | [%] |
| O | 8 | K-series | 59.87 | 61.98 | 67.47 | 7.7 |
| Mg | 12 | K-series | 28.83 | 29.84 | 21.39 | 1.6 |
| C | 6 | K-series | 7.22 | 7.47 | 10.83 | 1.4 |
| Ca | 20 | K-series | 0.68 | 0.71 | 0.31 | 0.1 |

The established composition in/Table 3/corresponds to spinel with the formula Zn_{0.49}Co_{0.47}Mn_{0.04}Cr₂O₄. It is quite close to the Zn_{0.53}Co_{0.48}Mn_{0.01}Cr₂O₄ composition determined by RFA of the sample. The analyzes in point 2 and point 3 were made in particles that are larger and differ in their morphology from those typical for the sample. In them, respectively, magnesium, aluminum and silicon were found in point 2 and magnesium in point 3. Item 2 is a relatively large inclusion, which differs in chemical composition from the material. The composition is magnesium aluminum silicate, containing a little iron and chromium. Point 3 is also in a relatively large inclusion that differs in chemical composition from the material. It is likely that the presence of similar phases is the reason for the more complex composition found in zone 1.

The elemental mapping performed, FIG. 5, shows a uniform distribution of the main elements: chromium, zinc, cobalt and oxygen. Crystals of escolaite Cr₂O₃ cannot be distinguished, the presence of which, as a companion phase to the main spinel phase, is evidenced by the XRD results. The reason may be related to the small size of the crystals and the uniform distribution of the two phases in the sample volume.

Characterization of compositions containing filler with spinel-type metal oxides, according to the invention:

Quantitative and qualitative composition of the vulcanizate based on butadiene styrene rubber/SBR/: SBR 100, zinc oxide 3, sulfur 1.75, stearic acid 1.5, vulcanization accelerator 1.25, filler 25 or 50 or 75 75 mass parts.

Dielectric and magnetic permeability of butadiene-styrene rubber-based vulcanizates containing spinel-type metal oxide fillers at different concentrations as follows:

### Permittivity

The measurements were made at a frequency of 2.565 GHz at different amounts of the filler according to the invention:

| | ε′ | ε″′ | σ, S/m | tanδ |
|---|---|---|---|---|
| SBR-25 | 3.112757 | 0.126113 | 0.017989 | 0.040513 |
| SBR-50 | 3.25404 | 0.137164 | 0.019565 | 0.042152 |
| SBR-75 | 3.499003 | 0.12807 | 0.018268 | 0.036616 |

The composition containing filler according to the invention in an amount of 75 mass parts shows extremely good performance and is preferred for substrates and insulating layers in antennas for wireless communications.
ε′—real part of permittivity
ε″—imaginary part of permittivity
σ—conductivity
tan δ—dielectric loss angle tangent

### Permeability

The measurements were made at a frequency of 2.644 GHz at different amounts of the filler according to the invention:

| | μᵣ′ | μᵣ″ |
|---|---|---|
| SBR-25 | 1.23586 | 0.03744 |
| SBR-50 | 1.248207 | 0.038992 |
| SBR-75 | 1.283822 | 0.026294 |

μᵣ′—real part of permeability
μᵣ″—imaginary part of permeability

Physicomechanical indicators:

| | M100, MPa | M300, MPa | σ, MPa | εᵣₑₗ, % | Sh, rel. units |
|---|---|---|---|---|---|
| unfilled | 0.9 | — | 1.75 | 245 | 55 |
| 1-25 phr | 1.40 | — | 2.34 | 250 | 58 |
| 2-50 phr | 1.55 | — | 2.52 | 265 | 62 |
| 3-75 phr | 1.70 | 3.0 | 3.0 | 300 | 64 |

Advantages provided by the composition according to the invention are:

The composition provides the convenience and flexibility of insulating layers and pads in flexible antennas. At the same time, it has a small value of the tangent of the dielectric loss angle (tan δ_{ε}), minimal absorption of electromagnetic power, the ability to withstand mechanical loads and possess a small change in the complex permittivity over a wide frequency range.

### BRIEF DESCRIPTION OF THE DRAWINGS

FIG. 1. X-ray diffractogram of the used filler

FIG. 2.a shows an SEM image of the investigated filler in secondary electron image mode,

FIG. 2.b shows an SEM image of the investigated filler in secondary electron image mode,

FIG. 2.c shows an SEM image of the investigated filler in secondary electron image mode,

FIG. 2.d shows an SEM image of the investigated filler in secondary electron image mode,

FIG. 2.e shows an SEM image of the investigated filler in secondary electron image mode,

FIG. 2.f shows an SEM image of the investigated filler in secondary electron image mode,

FIG. 2.g shows an SEM image of the investigated filler in backscattered electron image mode.

FIG. 2.h shows an SEM image of the investigated filler in backscattered electron image mode,

FIG. 3.1 shows results obtained by means of EDX in microzones, zone 1,

FIG. 3.2 shows results obtained by means of EDX in microzones, zone 2

FIG. 4.1 shows results obtained by means of EDX in point 1,

FIG. 4.2 shows results obtained by means of EDX in point 2,

FIG. 4.1 shows results obtained by means of EDX in point 3,

FIG. 5. Mapping by elements.

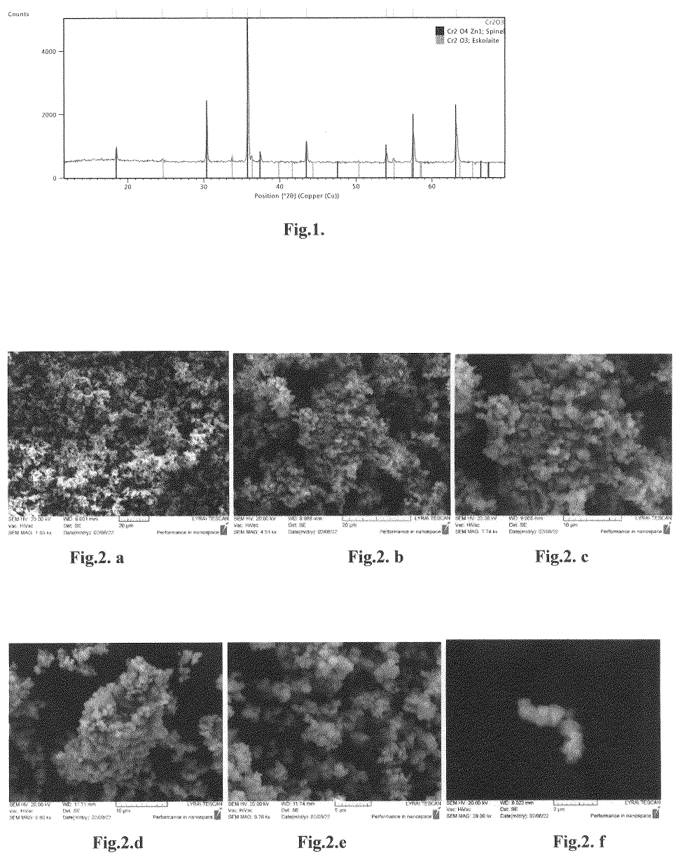

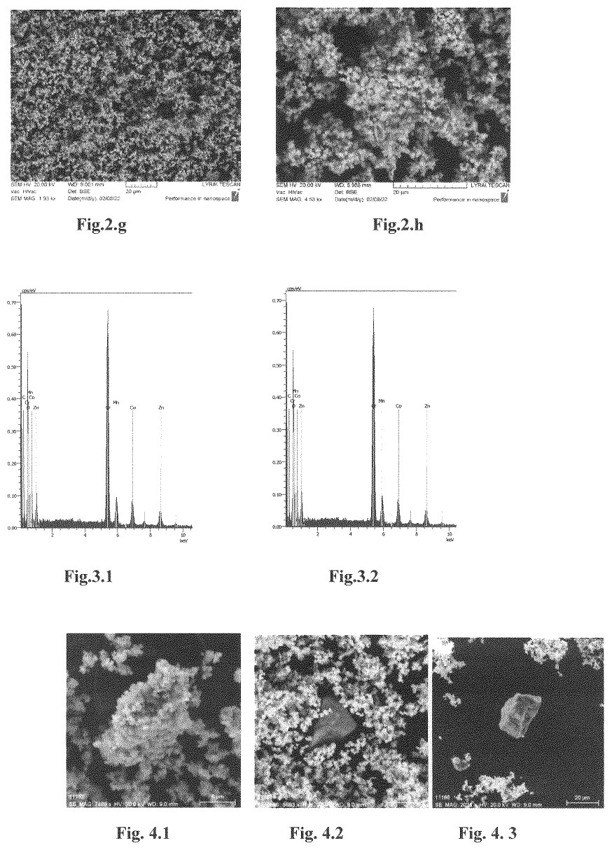

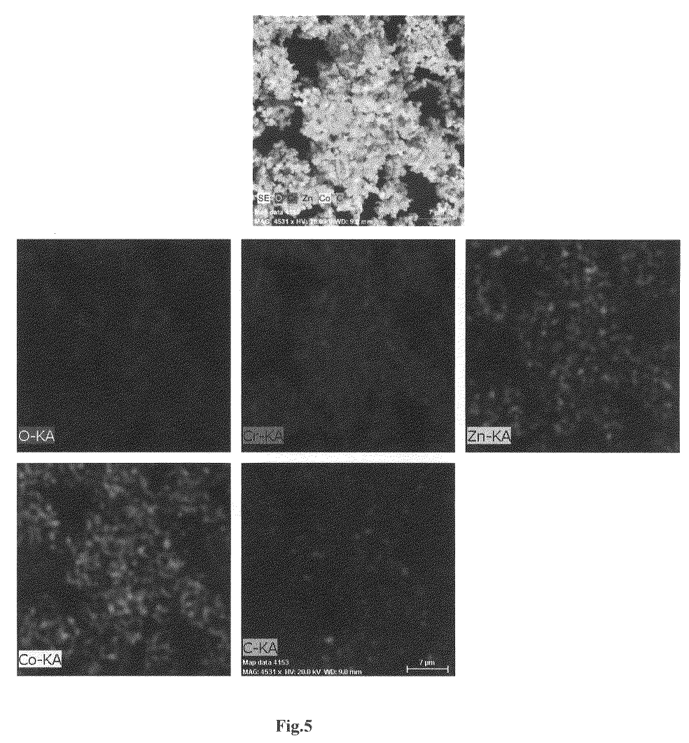

### DETAILED DESCRIPTION

The invention is disclosed in more detail with preferred exemplary embodiments without limiting it.

### Example 1

Composition of vulcanizate based on styrene butadiene rubber/SBR/ /in mass parts/Butadiene
styrene rubber/SBR/—100,
Zinc oxide—1
stearic acid—1
filler—25
vulcanization accelerator/TBBS/—1
sulfur 1.5

Technology of making the rubber mixture is carried out on an open laboratory rubber mixer (open laboratory two rolls mill) with the following sequence of operations and technological mode:

Initially, rubber is plasticized. At the 4th minute of plasticization, zinc oxide and stearic acid are added. After 3 minutes of homogenization, i.e. at the 7th minute add half of the filler. After another homogenization of 3 minutes, at the 10th minute, the second half of the filler is added. After another homogenization, at the 16th minute, the vulcanization accelerator (TBBS) and sulfur are added. After homogenization again for 4 minutes, i.e. at the 20th minute, the rubber mixture is already ready and removed from the two rolls mill.

### Example 2

Composition of vulcanizate based on styrene butadiene rubber/SBR/ /in mass parts/Butadiene
styrene rubber SBR—100,
Zinc oxide—5 mass parts
stearic acid—2 mass parts,
filler—75 mass parts
TBBS—1.5 mass parts,
sulfur of 2.0 mass parts

The technology of making the rubber mixture is as in example 1

### Example 3

Composition of vulcanization based on styrene butadiene rubber/SBR/ /in mass parts/Butadiene
styrene rubber SBR—100,
Zinc oxide—5 mass parts
stearic acid—2 mass parts,
filler—50 mass parts
TBBS—1.5 mass parts,
sulfur of 2.0 mass parts

The technology of making the rubber mixture is as in example 1

1. A composition comprising: spinel-type metal oxides, wherein the ingredients of 100 mass parts of styrene butadiene rubber SBR are: zinc oxide from 1 to 5 mass parts, stearic acid from 1 to 2 mass parts, filler from 25 to 75 mass parts TBBS vulcanization accelerator—from 1 to 1.5 mass parts, sulfur from 1.5 to 2.0, and the filler is a spinel type of metal oxides and is Zn_{0.53}Co_{0.48}Mn_{0.01}Cr₂O₄.

2. The composition containing spinel-type metal oxides, according to claim 1, wherein the chemical composition of the spinel-type metal oxides in weight percentages is: Cr—62, 10; Mn—0, 19; Co—16, 92; Zn—20, 79, and the particle sizes are from submicron 0.2-0.5 μm to 2-3 μm.
